(19) United States
(12) Patent Application Publication
(10) Pub. No.: US 2022/0082203 A1
(43) Pub. Date: Mar. 17, 2022

(54) FOLDABLE HANDHELD GIMBAL

(71) Applicant: SZ DJI TECHNOLOGY CO., LTD., Shenzhen (CN)

(72) Inventor: Tianfei Zhao, Shenzhen (CN)

(21) Appl. No.: 17/456,623

(22) Filed: Nov. 26, 2021

Related U.S. Application Data
(63) Continuation of application No. PCT/CN2019/088587, filed on May 27, 2019.

(51) Int. Cl. F16M 11/20; F16M 11/08

(52) U.S. Cl. CPC F16M 11/2057; F16M 2200/022; F16M 11/08

(57) ABSTRACT

A foldable handheld gimbal includes a handle, a first motor arranged at the handle and configured to drive a load to rotate around a first motor shaft, a first connection bracket, a second motor configured to drive the load to rotate around a second motor shaft, a second connection bracket, a third motor configured to drive the load to rotate around a third motor shaft, a carrier structure configured to carry the load, a first hinge structure, and a second hinge structure. The handle includes a top, a bottom, and a side wall arranged between the top and the bottom. The first connection bracket and the second motor respectively rotate around the first hinge structure and the second hinge structure to switch the handheld gimbal among a plurality of states. The first motor and the second motor are respectively arranged at the top and the bottom of the handle.

### CROSS-REFERENCE TO RELATED APPLICATION

This application is a continuation of International Application No. PCT/CN2019/088587, filed May 27, 2019, the entire content of which is incorporated herein by reference.

### TECHNICAL FIELD

The present disclosure relates to the field of gimbal technology and, more particularly, to a foldable handheld gimbal.

### BACKGROUND

When a handheld photographing device such as a mobile phone is used for shooting videos or images, the user's body or arm is easy to shake. As such, shaking or blur may occur in the captured images. Therefore, when the user uses the handheld photographing device for shooting, a handheld gimbal is usually used to fix the handheld photographing device, so as to adjust a shooting angle of the handheld photographing device and stabilize the handheld photographing device at the determined shooting angle. However, the current handheld gimbal is relatively large, and the size is the same in a working state and a non-working state, which is inconvenient for a user to carry and store, thereby affecting the user experience.

### SUMMARY

In accordance with the disclosure, there is provided a foldable handheld gimbal includes a handle, a first motor arranged at the top of the handle and configured to drive a load to rotate around a first motor shaft, a first connection bracket with one end of the first connection bracket connected to the first motor, a second motor connected to another end of the first connection bracket and configured to drive the load to rotate around a second motor shaft, a second connection bracket with one end of the second connection bracket connected to the second motor, a third motor connected to another end of the second connection bracket and configured to drive the load to rotate around a third motor shaft, a carrier structure fixedly connected to a rotor of the third motor and configured to carry the load, a first hinge structure hinged to the first motor and the first connection bracket, and a second hinge structure hinged to the first connection bracket and the second motor. The handle includes a top, a bottom, and a side wall arranged between the top and the bottom. The first connection bracket and the second motor respectively rotate around the first hinge structure and the second hinge structure to switch the handheld gimbal among a plurality of states including a folded state. The first motor and the second motor are respectively arranged at the top and the bottom of the handle.

### BRIEF DESCRIPTION OF THE DRAWINGS

FIG. 1 is a schematic structural diagram of a handheld gimbal from a viewing angle according to some embodiments of the present disclosure.

FIG. 2 is a schematic structural diagram of the handheld gimbal in FIG. 1 from another viewing angle.

FIG. 3 is a schematic structural diagram of a load according to some embodiments of the present disclosure.

FIG. 4 is a schematic structural diagram of the handheld gimbal in FIG. 1, where a first connection bracket is folded about a hinge joint, and a second motor and a second connection bracket are not folded about hinge joints.

FIG. 5 is a schematic structural diagram of the handheld gimbal in FIG. 1, where a first connection bracket and the second motor are folded about hinge joints, and a second connection bracket is not folded about a hinge joint.

FIG. 6 is a schematic structural diagram of the handheld gimbal in FIG. 1 in the folded state at a viewing angle.

FIG. 7 is a schematic structural diagram of the handheld gimbal in FIG. 6 in the folded state at another viewing angle.

FIG. 8 is a partial structural diagram of the handheld gimbal according to some embodiments, showing a handle, a first motor, and a first hinge member.

FIG. 9 is a partial structural diagram of the handheld gimbal in FIG. 1, showing a second hinge member, the first connection bracket, a second motor, a second connection bracket, a second hinge structure, the third motor, and a carrier structure.

FIG. 10 is a partially enlarged schematic diagram of handheld gimbal at A in FIG. 9.

FIG. 11 is a partial structural diagram of the handheld gimbal in FIG. 1, showing a second hinge member, the first connection bracket, the second motor, a second connection bracket, a second hinge structure, a third motor, and a carrier structure.

FIG. 12 is a partial cross-section view of the handheld gimbal according to some embodiments of the present disclosure, showing a first shaft assembly, the first hinge member, a second hinge member, and the first connection bracket.

FIG. 13 is a schematic structural diagram of a first lock member of the handheld gimbal in FIG. 11.

FIG. 14 is a schematic structural diagram of a second lock member of the handheld gimbal in FIG. 11.

FIG. 15 is a schematic structural diagram of a handheld gimbal according to some embodiments of the present disclosure, showing the handle, the first motor, the first hinge member, the first shaft assembly, the second hinge member, and the first connection bracket.

FIG. 16 is a partial cross-section view of the handheld gimbal according to some embodiments of the present disclosure, showing the first lock member, the first hinge member, and the second hinge member.

### DESCRIPTION OF REFERENCE NUMERALS

100, handheld gimbal; 110, handle; 111, top; 112, bottom; 113, side wall; 121, first motor; 122, second motor; 123, third motor; 130, first connection bracket; 131, first bracket body; 132, first plane member; 133, second plane member; 140, second connection bracket; 141, second bracket body; 142, matching member; 150, carrier structure; 151, main body; 152, clamp member;

160, first hinge structure; 161, first hinge member; 1611, first connection hole; 162, second hinge member; 1621, second connection hole; 163, first shaft assembly; 1631, first lock mechanism; 16311, first limit hole; 16312, second elastic member; 16313, second limit hole; 16314, positioning member; 1632, first shaft; 1633, first lock member; 1634, second lock member; 1635, convex structure; 16351, highest point of convex; 16352, lowest point of convex; 1636, concave structure; 16361, lowest point of concave; 1637, first elastic member;

170, second hinge structure; 171, third hinge member; 172, fourth hinge member; 173, second shaft assembly; 180, accommodation space; 181, fifth hinge member; 182, sixth hinge member; 183, third shaft assembly; 190, control assembly; 191, operation member;

200, load; 300, mobile phone; Y, first motor shaft; P, second motor shaft; R, third motor shaft.

### DETAILED DESCRIPTION OF THE EMBODIMENTS

Implementation manners of the present disclosure are described in detail. Embodiments of the described implementation manner are shown in drawings. The same or similar reference numerals indicate the same or similar elements or elements with the same or similar functions. The implementation manners described in conjunction with accompanying drawings are merely used to explain the present disclosure and should not be considered as a limitation to embodiments of the present disclosure.

In the description of embodiments of the present disclosure, orientational or positional relationship indicated by a term such as “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” or “counterclockwise” is based on the orientational or positional relationship shown in the drawings, and is only used to facilitate the description of embodiments of the present disclosure and simplify the description, rather than indicating or implying that the device or element referred to must have a specific orientation and be constructed and operated in a specific orientation. Therefore, the terms should not be understood to limit embodiments of the present disclosure. In addition, the terms “first” and “second” are used for descriptive purposes only and should not be understood to indicate or imply relative importance or implicitly indicate the number of indicated technical features. Thus, a feature as associated with “first” and “second” may explicitly or implicitly include one or more of the features. In the description of embodiments of the present disclosure, the meaning of “plurality” is two or more, unless otherwise specified.

According to some embodiments of the present disclosure, a handheld gimbal 100 includes a handle 110 and a stabilization gimbal structure connected to the handle 110. The stabilization gimbal structure includes a first motor 121, a second motor 122, a third motor 123, connection brackets, and hinge structures. The stabilization gimbal structure may be detachably connected to the handle 110. The stabilization gimbal structure may also be detachably connected to another carrier, such as an unmanned aerial vehicle (UAV), a vehicle, or a ground remote control vehicle, etc. The stabilization gimbal structure may be quickly connected to the above-described carrier, such that the stabilization gimbal structure may be switched between different carriers. For example, the stabilization gimbal structure may be switched between the UAV and the handle 110, or the stabilization gimbal structure may be switched between the ground remote control vehicle and the handle 110.

The handheld gimbal 100 provided by embodiments of the present disclosure includes a folding function, so that the handheld gimbal 100 may be switched between an unfolded state (also referred to as a “use state”) and a folded state (also referred to as a “storage state”). When the handheld gimbal is switched from the use state to the storage state, each motor may be switched from a power-on mode to the power-off mode. Oppositely, when the handheld gimbal is switched from the storage state to the unfolded state, each motor may be switched from a power-off mode to the power-on mode. For example, when the handheld gimbal is switched from the use state to the storage state, two connection brackets start to rotate relative to each other. When an angle between the extension directions of the two connection brackets is smaller than a certain angle, at least one of a first motor 121, a second motor 122, or a third motor 123 is switched from the power-on mode to the power-off mode.

The angle between the extension directions of the two connection brackets being smaller than a certain angle can be that the angle is smaller than 90°, 80°, 70°, or 45°, which is not limited here.

In some embodiments, at least one of the first motor 121, the second motor 122, or the third motor 123 being switched from the power-on mode to the power-off mode can be that only the first motor 121, the second motor 122, or the third motor 123 is switched from the power-on mode to the power-off mode, that two of the three motors, such as the first motor 121 and the second motor 122, the first motor 121 and the third motor 123, or the second motor 122 and the third motor 123, are switched from the power-on mode to the power-off mode, or that all the three motors are switched from the power-on mode to the power-off mode.

Thus, when the handheld gimbal is switched from the use state to the storage state, one or more of the motors are directly switched from the power-on mode to the power-off mode. Similarly, when the handheld gimbal is switched from the storage state to the use state, one or more of the motors are directly switched from the power-off mode to the power-on mode. As such, not only battery power of the handheld gimbal can be saved, but also the convenient operation of the handheld gimbal for the user can be facilitated.

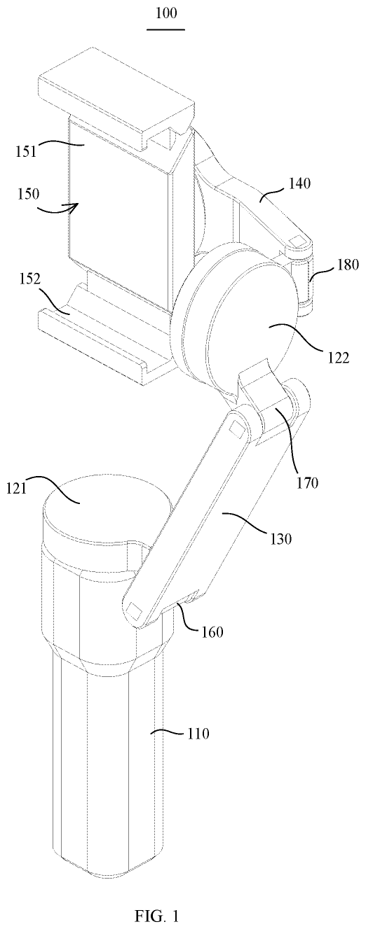

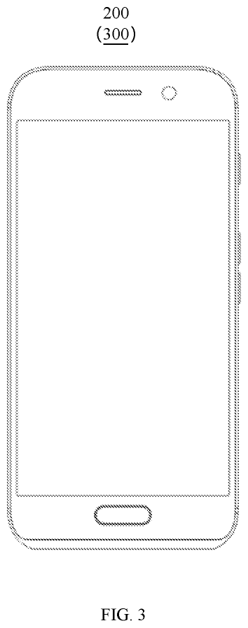

As shown in FIG. 1 to FIG. 7, embodiments of the present disclosure provide the foldable handheld gimbal 100. The foldable handheld gimbal 100 may be configured to carry a load 200, so as to adjust the position and orientation of the load 200, thereby meeting the work requirements of various scenarios. In some embodiments, the handheld gimbal 100 may also compensate for the vibration of the load 200 through rotation, so as to stabilize and balance the load 200. As such, the load 200 may work at a better attitude, thereby obtaining more accurate information.

In some embodiments, the load 200 may include one of an imaging device, a mobile terminal, or a sensor, etc. The imaging device may include a video camera, a camera, an ultrasound imaging device, an infrared (IR) imaging device, a camera lens, or other imaging devices. The mobile terminal may include a mobile phone, or a tablet, etc. The sensor may include an attitude sensor, such as an angle sensor, or an acceleration sensor, etc. In some embodiments, the imaging device may also include a mobile terminal, such as a mobile phone or a tablet computer with video recording and photographing functions, or another imaging device.

As shown in FIG. 1 to FIG. 3, in some embodiments of the present disclosure, a mobile phone 300 with video recording and photographing functions is taken as an example. Users may perform imaging work with the mobile phone 300 carried by the above-described handheld gimbal 100. The handheld gimbal stabilizes or controls the attitude of the mobile phone 300.

As shown in FIG. 1 to FIG. 7, in some embodiments, the handheld gimbal 100 includes the handle 110, the first motor 121, a first connection bracket 130, a second connection bracket 140, the third motor 123, a carrier structure 150, a first hinge structure 160, and a second hinge structure 170.

As shown in FIG. 1 to FIG. 7, in some embodiments, the first motor 121 is hinged with the first connection bracket 130 through the first hinge structure 160. The first connection bracket 130 is hinged with the second motor 122 through the second hinge structure 170. The first connection bracket 130 and the second motor 122 may rotate around the first hinge structure 160 and the second hinge structure 170, respectively, so that the handheld gimbal 100 can be switched from the use state to the folded state. The first motor 121 and the second motor 122 are arranged at a top 111 of the handle 110 and a bottom 112 of the handle 110, respectively.

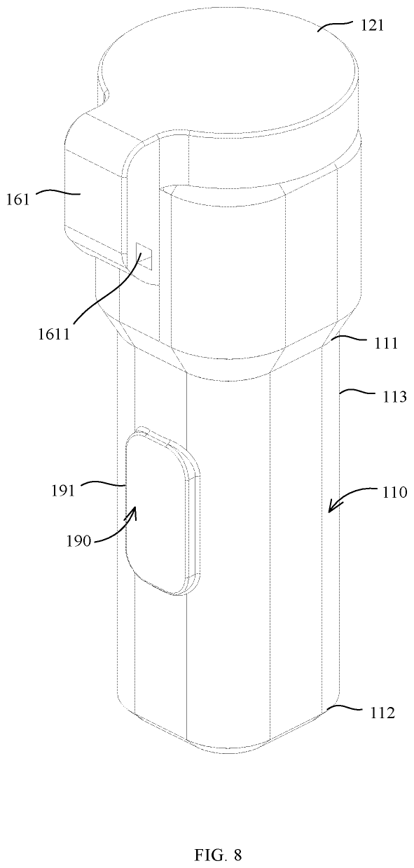

In some embodiments, the handle 110 may be any suitable shape. As shown in FIG. 1 and FIG. 8, the handle is configured to provide the user to hold and operate the handheld gimbal 100. The handle includes the top 111, the bottom 112, and side walls 113. The side wall 113 is arranged between the top 111 and the bottom 112.

As shown in FIG. 1 to FIG. 7, in some embodiments, the first motor 121 is mounted at the top 111 of the handle 110. One end of the first connection bracket 130 is connected to the first motor 121. The second motor 122 is connected to the other end of the connection bracket 130. One end of the second connection bracket 140 is connected to the second motor 122. The third motor 123 is connected to another end of the second connection bracket 140. The first motor 121 is hinged with the first connection bracket 130 through the first hinge structure 160, the first connection bracket 130 is hinged with the second motor through the second hinge structure 170, and second motor 122 is hinged with the second connection bracket 140 through the third hinge structure 180. As such, when the handheld gimbal 100 is not in use, the first connection bracket 130, the second motor 122, and the second connection bracket 140 may rotate around the hinge joint, so that the handheld gimbal 100 can be switched from the use state to the folded state. The first motor 121 and the second motor 122 are respectively arranged at the top 111 and the bottom 112, so that the entire volume of the handheld gimbal 100 can be reduced, as such, the handheld gimbal 100 occupies a small space and is easy for users to store and carry, which improves the user experience.

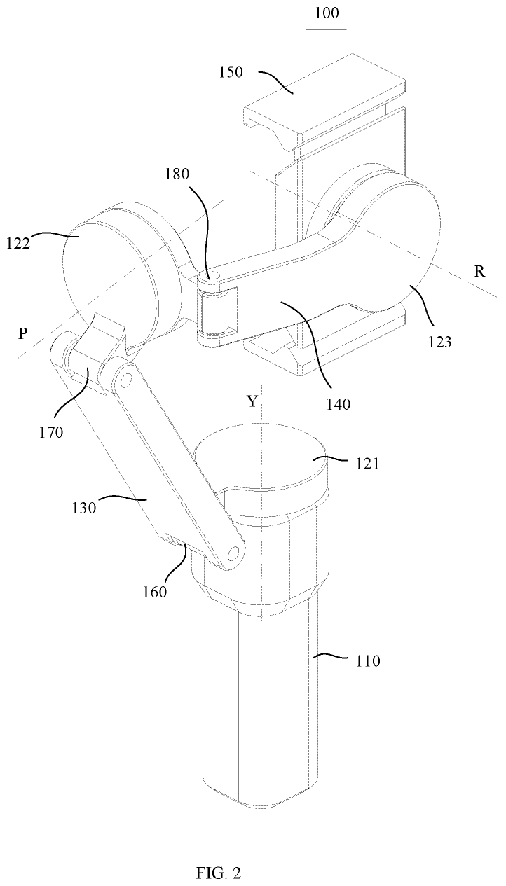

As shown in FIG. 1 and FIG. 2, the first motor 121 is configured to drive the load 200 to rotate around a first motor shaft Y. In some embodiments, the handle 110 and the first connection bracket 130 are both connected to the first motor 121. One end of the first connection bracket 130 is connected to the first motor 121. Another end of the connection bracket 130 is connected to the second motor 122. In some embodiments, the handle 110 is connected to a stator of the first motor 121, and the first connection bracket 130 is connected to a rotor of the first motor 121. When the rotor of the first motor 121 rotates around the first motor shaft Y relative to the stator of the first motor 121, the first motor 121 may also drive the first connection bracket 130, the second motor 122, the second connection bracket 140, the third motor 123, and the load 200 to rotate around the motor shaft Y of the above-described handheld gimbal 100.

As shown in FIG. 1 to FIG. 7, the second motor 122 is configured to drive the load 200 to rotate around a second motor shaft P. In some embodiments, one end of the second motor 122 is connected to the first connection bracket 130. Another end of the second motor 122 is connected to the second connection bracket 140. One end of the second connection bracket 140 opposite to the second motor 122 is connected to the third motor 123. In some embodiments, the first connection bracket 130 is connected to a stator of the second motor 122, and the second connection bracket 140 is connected to a rotor of the second motor 122. When the rotor of the second motor 122 rotates relative to the stator of the second motor 122, the rotor of the second motor 122 may drive the second connection bracket 140, the third motor 123, and the load 200 to rotate around the second motor shaft P of the handheld gimbal 100.

As shown in FIG. 1 and FIG. 2, the third motor 123 is configured to drive the load 200 to rotate around the third motor shaft R. One end of the third motor 123 is connected to the second connection bracket 140. Another end of the second motor 123 may be directly connected to the carrier structure 150. The carrier structure 150 is configured to carry and fix the load 200. The carrier structure 150 is fixedly connected to the rotor of the third motor 123. In some embodiments, the second connection bracket 140 may be connected to a stator of the third motor 123. The carrier structure 150 may be connected to a rotor of the third motor 123. When the rotor of the third motor 123 rotates relative to the stator of the third motor 123, the carrier structure 150 and the load 200 may rotate around the third motor shaft R of the handheld gimbal 100.

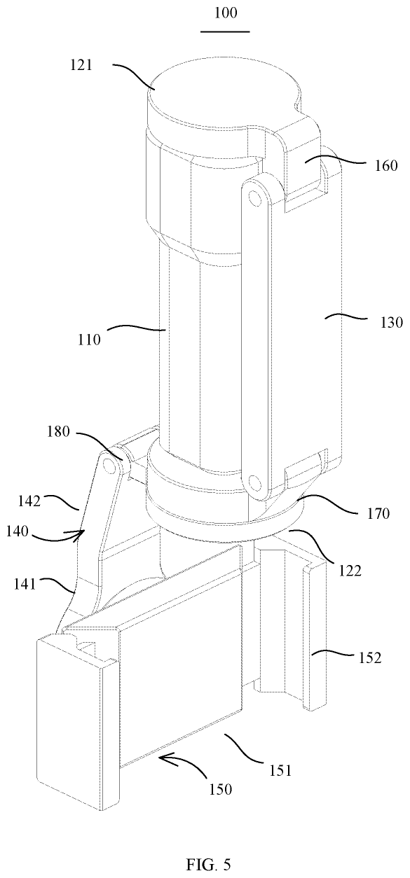

As shown in FIG. 1 and FIG. 5, the carrier structure 150 is configured to carry the mobile terminal with an imaging function, such as the mobile phone 300. The carrier structure 150 may be a clamp structure. In some embodiments, the carrier structure 150 includes a main body 151 and a clamp member 152. The main body 151 is connected to the rotor of the third motor 123. The main body 151 is configured to abut against a back of the mobile phone 300. The clamp member 152 is configured to fix the mobile phone 300 to the main body 151. To facilitate the mounting of mobile phone 300 with different sizes, the clamping size of the clamp member 152 may be adjusted according to practical needs. For example, the clamp member 152 includes two oppositely arranged movable clamps to help to clamp the mobile phone 300. In some embodiments, the clamping size of the clamp member 152 may be adjusted via the cooperation of, e.g., gears and racks. In some embodiments, the carrier structure 150 may also include oppositely arranged sliding grooves (not shown), so as to facilitate the mobile phone 300 to be mounted to the carrier structure via the sliding grooves.

In some embodiments, the carrier structure 150 may also include an imaging device, such as an imaging lens, or a camera with lens, etc. Take the imaging lens as an example, in some embodiments, the carrier structure 150 includes a movable part and a fixed part. The movable part and the fixed part are rotatably connected, as such, the movable part may be moved toward the fixed part or separated from the fixed part. The closure or the separation between the movable part and the fixed part may be implemented through a lock member, such as a snap-lock structure. The shape of the movable part and the fixed part match the imaging lens. When the movable part closes with the fixed part, the imaging lens may be locked to be fixed at the handheld gimbal 100. When the imaging lens needs to be removed, the lock member is operated to make the movable part separate from the fixed part, thereby loosening the imaging lens to facilitate the removal of the lens from the handheld gimbal 100. Further, the imaging lens may be a square lens, a circular lens, or an irregular shape lens, etc. In addition, the size and model of the imaging lens may also be selected according to the user's needs and is not limited here.

In some embodiments, the load 200 may swing around the first motor shaft Y, the second motor shaft P, and the third motor shaft R. As such, the handheld gimbal 100 may stabilize or control the attitude of the load 200 in three different axial directions, such that the load 200 may be maintained in better and more working states.

As shown in FIG. 1 and FIG. 2, in some embodiments of the present disclosure, the first motor 121 may include a yaw motor, and the first motor shaft Y is a yaw motor shaft. The second motor 122 may include a pitch motor, and the second motor shaft P is a pitch motor shaft. The third motor 123 may include a roll motor, and the third motor shaft R is a roll motor shaft.

In some embodiments, the first motor shaft Y and the third motor shaft R are approximately perpendicular to each other. In this disclosure, two items being “approximately perpendicular” to each other means that an angle between the two items is in a range of 85°˜95°. The first motor shaft Y is non-orthogonal to the second motor shaft P, and the second motor shaft P is non-orthogonal to the third motor shaft R. The angle between the first motor shaft Y and the second motor shaft P can be an acute angle or obtuse angle, and the angle between the second motor shaft P and the third motor shaft R can be an acute angle or obtuse angle. In some embodiments, the angle between the first motor shaft Y and the second motor shaft P may be an acute angle, for example, 45°. The angle between the second motor shaft P and the third motor shaft R may be an obtuse angle, for example, 135°.

In the above-described embodiments, the first motor 121 may control the attitude of the load 200 in the yaw direction, the second motor 122 may control the attitude of the load 200 in the pitch direction, and the third motor 123 may control the attitude of the load 200 in the roll direction. Thus, the handheld gimbal 100 may realize three-axis stabilization and attitude control for the load 200, such that the load 200 may be maintained in a better attitude.

The first motor shaft Y, the second motor shaft P, and the third motor shaft R are actual shafts of the handheld gimbal 100. The dotted lines shown in FIG. 2 are the axes of the first motor shaft Y, the second motor shaft P, and the third motor shaft R.

As shown in FIG. 1 to FIG. 7, in some embodiments of the present disclosure, the first hinge structure 160 is hinged to the first motor 121 and the first connection bracket 130. The first hinge structure 160 allows the first connection bracket 130 to rotate relative to the first motor 121 between the unfolded state and the folded state. In some embodiments, other intermediate states may be set between the folded state and the unfolded. A rotation angle of the first connection bracket 130 about the hinge joint may be designed according to actual requirements. For example, the rotation angle of the first connection bracket 130 about the hinge joint is 100°˜150°. In an implementation manner, the rotation angle of the first connection bracket 130 may be 120°. In some other implementation manners, the rotation angle of the first connection bracket 130 may also be 100°, 150°, or any suitable angle between the two angles.

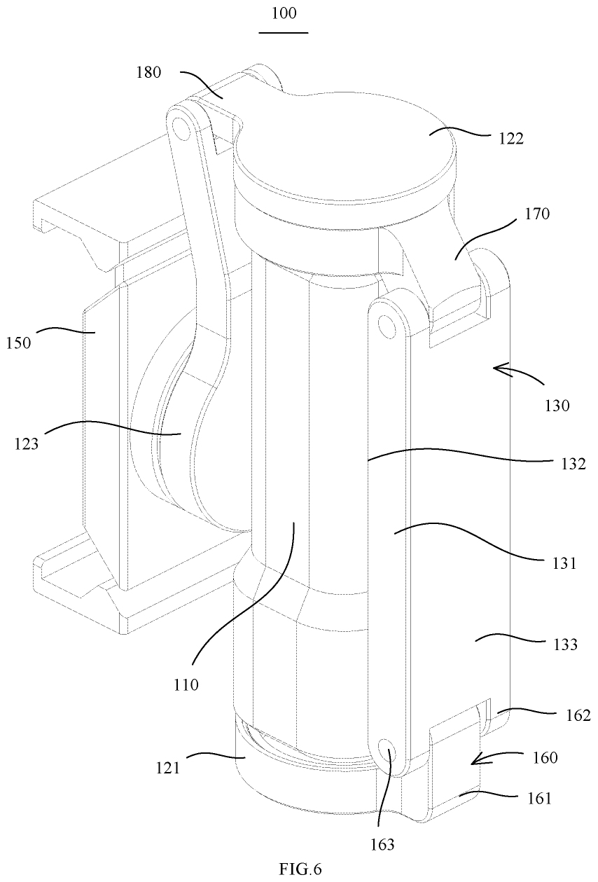

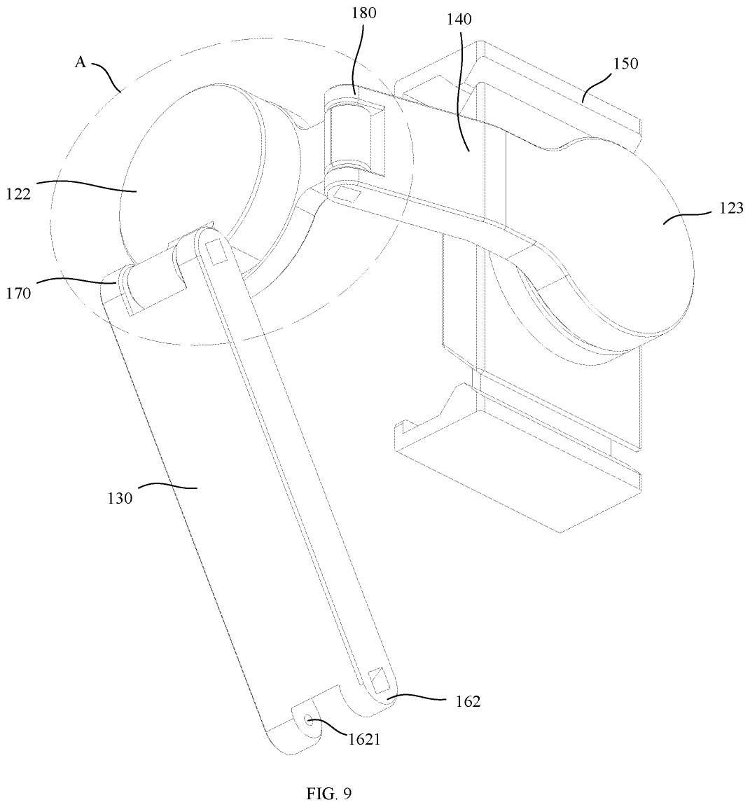

As shown in FIG. 6, FIG. 8, and FIG. 9, the first hinge structure 160 includes a first hinge member 161, a second hinge member 162, and a first shaft assembly 163. The first hinge member 161 extends outward from the outer periphery of the first motor 121. In some embodiments, the first hinge member 161 extends outward from the outer periphery of the first motor 121. Compared with scenarios in which the first hinge member 161 is arranged at other positions of the first motor 121, the above-described arrangement not only can allow the first hinge member 161 to cooperate with the second hinge member 162 to cause the first connection bracket 130 to rotate around the hinge point but also can relatively reduce the overall volume of the handheld gimbal 100 in the folded state. The second hinge member 162 extends from one end of the first connection bracket 130 that is away from the second motor 122. The first shaft assembly 163 is connected to the first hinge member 161 and the second hinge member 162. The first shaft assembly 163 is configured to hinge the first motor 121 and the first connection bracket 130.

The first hinge member 161 and the second hinge member 162 may be arranged at any suitable position of the first shaft assembly 163, as long as the first hinge member 161, the second hinge member 162, and the first shaft assembly 163 can cooperate to realize the hinge connection of the first motor 121 and the first connection bracket 130. For example, the first hinge member 161 may be arranged at an end of the first shaft assembly 163, or the second hinge member 162 may be arranged at a middle of the first shaft assembly 163. As another example, the first hinge member 161 may be arranged at the middle of the first shaft assembly 163, and the second hinge member 162 may be arranged at the end of the first shaft assembly 163. As another example, the first hinge member 161 may be arranged at one end of the first shaft assembly 163, and the second hinge member 162 may be arranged at the other end of the first shaft assembly 163.

Any suitable number of the first hinge member 161 and the second hinge member 162 may be set according to actual needs. For example, the number of the first hinge member 161 is one and the number of the second hinge member 162 is two, and the two second hinge members 162 extend along the same end of the first connection bracket 130 at an interval. The two second hinge members 162 can be arranged at two ends of the first shaft assembly 163, respectively. The first hinge member 161 is arranged at a position at the middle or close to the middle of the first shaft assembly 163.

As shown in FIG. 8 and FIG. 9, a first connection hole 1611 is arranged at the first hinge member 161 along the axial direction of the first shaft assembly 163. A second connection hole 1621 is arranged at the second hinge member 162 along the axial direction of the first shaft assembly 163. The second connection hole 1621 matches the first connection hole 1611. The first shaft assembly 163 is arranged through the first connection hole 1611 and the second connection hole 1621 to hinge the first hinge member 161 and the second hinge member 162, as such, the first motor 121 and the first connection bracket 130 may be hinged to each other. The shape of the first connection hole 1611 and that of the second connection hole 1621 may be designed to be any suitable shapes, such as square holes, circular holes, other regular-shaped holes, or irregular-shaped holes, etc., as long as the designed holes match the first shaft assembly 163 to realize the hinge connection between the first motor 121 and the first connection bracket 130.

As shown in FIG. 1 to FIG. 7, in some embodiments of the present disclosure, the handheld gimbal 100 includes a second hinge structure 170 hinged between the first connection bracket 130 and the second motor 122. The second hinge structure 170 can make the second motor 122 rotate relative to the first connection bracket 130 between the unfolded state and the folded state. In some embodiments, other intermediate states may be set between the folded state and the unfolded. A rotation angle of the second motor 122 about the hinge joint may be designed according to actual requirements. For example, the rotation angle of the second motor 122 about the hinge joint may be 100°˜150°. In an implementation manner, the rotation angle of the second motor 122 may be 120°. In some other implementation manners, the rotation angle of the second motor 122 may also be 100°, 150°, or any other suitable angle between the two angles.

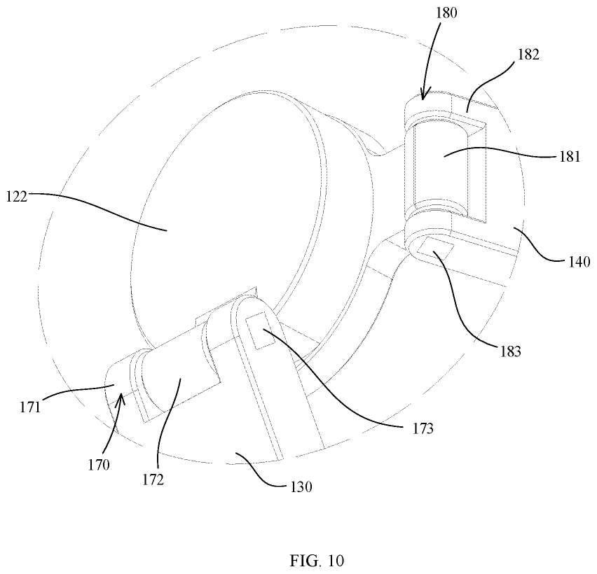

As shown in FIG. 9 and FIG. 10, in some embodiments, the second hinge structure 170 includes a third hinge member 171, a fourth hinge member 172, and a second shaft assembly 173. The third hinge member 171 extends from an end of the first connection bracket 130 away from the first motor 121. The fourth hinge member 172 extends outward from the outer periphery of the second motor 122. The second shaft assembly 173 is connected to the third hinge member 171 and the fourth hinge member 172, which is configured to hinge the first connection bracket 130 and the second motor 122.

The third hinge member 171 and the fourth hinge member 172 may be arranged at any suitable position of the second shaft assembly 173, as long as the third hinge member 171, the fourth hinge member 172, and the second shaft assembly 173 can cooperate to realize the hinge connection of the first connection bracket 130 and the second motor 122. For example, the third hinge member 171 may be arranged at an end of the second shaft assembly 173, and the fourth hinge member 172 may be arranged at a middle of the second shaft assembly 173. As another example, the third hinge member 171 may be arranged at the middle of the second shaft assembly 173, and the fourth hinge member 172 may be arranged at an end of the second shaft assembly 173. As another example, the third hinge member 171 may be arranged at one end of the second shaft assembly 173, and the fourth hinge member 172 may be arranged at the other end of the second shaft assembly 173.

As shown in FIGS. 1-7, FIG. 9, and FIG. 10, the fourth hinge member 172 may extend outward from any suitable position on the outer periphery of the second motor 122, as long as the fourth hinge member 172 can be hinged with the third hinge member 171 and the second shaft assembly 173. For example, the fourth hinge member 172 extends outward from the side periphery of the second motor 122, and the fourth hinge member 172 corresponds to the position of the third hinge member 171 of the first connection bracket 130.

In some embodiments, the second shaft assembly 173 may be any suitable structures, as long as the third hinge member 171, the fourth hinge member 172, and the second shaft assembly 173 can cooperate to realize the hinge connection of the first connection bracket 130 and the second motor 122. In some embodiments, the structure of the second shaft assembly 173 is approximately the same as the structure of the first shaft assembly 163.

As shown in FIG. 1 to FIG. 7, FIG. 9, and FIG. 10, in some embodiments of the present disclosure, the handheld gimbal 100 further includes a third hinge structure 180 hinged between the second connection bracket 140 and the second motor 122. The third hinge structure 180 can make the second motor 122 rotate relative to the second connection bracket 140 between the unfolded state and the folded state. In some embodiments, other intermediate states may be set between the folded state and the unfolded. A rotation angle of the second connection bracket 140 about the hinge joint may be designed according to actual requirements. For example, the rotation angle of the second connection bracket 140 about the hinge joint may be 135°˜215°. In an implementation manner, the rotation angle of the second connection bracket 140 may be 180°. In some other implementation manners, the rotation angle of the second connection bracket 140 may also be 135°, 215°, or any other suitable angle between the two angles.

As shown in FIG. 9 and FIG. 10, in some embodiments, the third hinge structure 180 includes a fifth hinge member 181, a sixth hinge member 182, and a third shaft assembly 183. The fifth hinge member 181 extends outward from the outer periphery of the second motor 122. The sixth hinge member 182 extends from one end of the second connection bracket 140 that faces the second motor 122. The third shaft assembly 183 is connected to the fifth hinge member 181 and the sixth hinge member 182, which is configured to hinge the second connection bracket 140 and the second motor 122.

To effectively reduce the overall volume of the handheld gimbal 100, when the handheld gimbal 100 is in the folded state, the fifth hinge member 181 extends outward from the side periphery of the second motor 122, and the fifth hinge member 181 corresponds to the position of the sixth hinge member 182 of the second connection bracket 140.

The fifth hinge member 181 and the sixth hinge member 182 may be arranged at any position of the third shaft assembly 183, as long as the fifth hinge member 181, the sixth hinge member 182, and the third shaft assembly 183 can cooperate to realize the hinge connection of the second connection bracket 140 and the second motor 122. For example, the fifth hinge member 181 may be arranged at an end of the third shaft assembly 183, and the sixth hinge member 182 may be arranged at a middle of the third shaft assembly 183. As another example, the fifth hinge member 181 may be arranged at the middle of the third shaft assembly 183, and the sixth hinge member 182 may be arranged at an end of the third shaft assembly 183. As another example, the fifth hinge member 181 may be arranged at one end of the third shaft assembly 183, and the sixth hinge member 182 may be arranged at the other end of the third shaft assembly 183.

In some embodiments, the fourth hinge member 172 and the fifth hinge member 181 are arranged at two sides of the second motor 122, that is, the fourth hinge member 172 and the fifth hinge member 181 are arranged at the different positions. In some embodiments, the fourth hinge member 172 and the fifth hinge member 181 extend outward from the side periphery of the second motor 122. The fourth hinge member 172 is arranged at the stator of the second motor 122, and the fifth hinge member 181 is arranged at the rotor of the second motor 122.

As shown in FIG. 1 to FIG. 7, FIG. 9, and FIG. 10, in some embodiments, when the handheld gimbal 100 is in the unfolded state, the angle between an extension direction of the fourth hinge member 172 and the extension direction of the fifth hinge member 181 may be 75°˜105°. In an implementation manner, when the handheld gimbal 100 is in the unfolded state, the angle between the extension direction of the fourth hinge member 172 and the extension direction of the fifth hinge member 181 may be 90°. In some other implementation manners, when the handheld gimbal 100 is in the unfolded state, the angle between the extension direction of the fourth hinge member 172 and the extension direction of the fifth hinge member 181 maybe 75°, 105°, or any other suitable angle between the two angles.

When the handheld gimbal 100 is in the folded state, the angle between an extension direction of the fourth hinge member 172 and the extension direction of the fifth hinge member 181 may be 165°˜180°. In an implementation manner, when the handheld gimbal 100 is in the folded state, the angle between the extension direction of the fourth hinge member 172 and the extension direction of the fifth hinge member 181 may be 180°. In some other implementation manners, when the handheld gimbal 100 is in the folded state, the angle between the extension direction of the fourth hinge member 172 and the extension direction of the fifth hinge member 181 may be 165°, 180°, or any other suitable angle between the two angles.

In some embodiments, the third shaft assembly 183 may be any suitable structures, as long as the fifth hinge member 181, the sixth hinge member 182, and the third shaft assembly 183 can cooperate to realize the hinge connection of the second connection bracket 140 and the second motor 122. In some embodiments, the structure of the third shaft assembly 183 is approximately the same as the structure of the second shaft assembly 173.

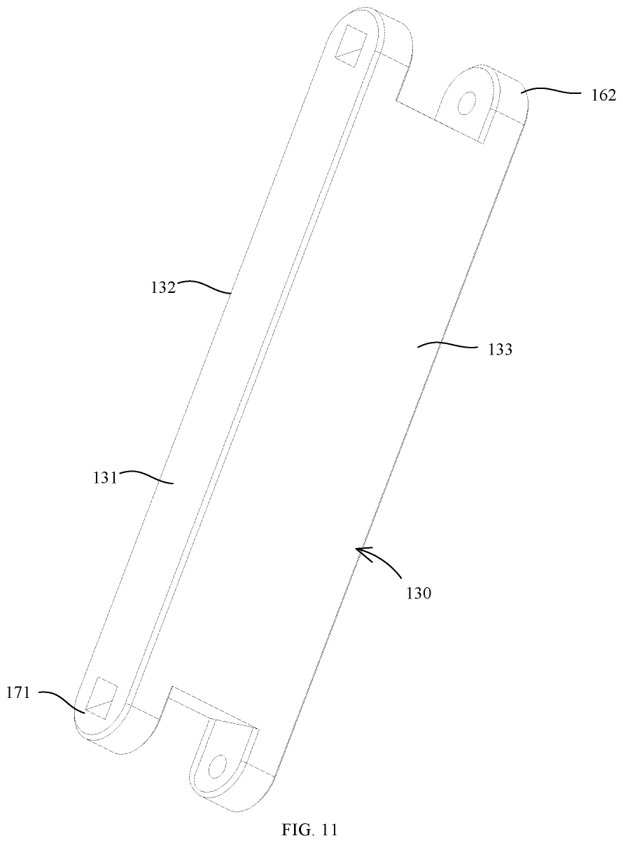

The first connection bracket 130 may be designed for any suitable structure. In some embodiments, to reduce the overall volume of the folded handheld gimbal 100, a length of the first connection bracket 130 is less than or equal to a length of the handheld gimbal 110. As shown in FIG. 6 and FIG. 11, the first connection bracket 130 includes a first bracket body 131 and a first plane member 132.

One end of the first bracket body 131 is connected to the first motor 121, another end of the first bracket body 131 is connected to the second motor 122. The first bracket body 131 may be in any suitable shape, such as a long-stripe shape, or L shape.

The first plane member 132 is arranged on one side of the bracket body 131. When the handheld gimbal 100 is in the folded state. The first plane member 132 is arranged at the side of the first bracket body 131 towards the handle 110. The extension direction of the first bracket body 131 is approximately parallel to the extension direction of the handle 110, which means that the angle between the extension direction of the first bracket body 131 and the extension direction of the handle 110 is 0°˜10°, for example, 0°, 10°, or any angle between the two. To reduce the overall volume of the handheld gimbal 100 in the folded state for storing and carrying, the first plane member 132 may partially abut against the handle 110. In some embodiments, when the handheld gimbal 100 is in the folded state, the first plane member 132 may partially abut against the side wall 113 of the handle 110.

In some embodiments, the first connection bracket 130 may further include a second plane member 133. The second plane member 133 and the first plane member 132 are oppositely arranged at two sides of the first bracket body 131.

As shown in FIG. 5, the second connection bracket 140 includes a second bracket body 131 and a matching member 142. One end of the second bracket body 141 is connected to the second motor 122, another end of the second bracket body 141 is connected to the third motor 123. The second bracket body 141 may be in any suitable shape, such as an a long-stripe shape, or L shape. The matching member 142 is arranged at the side of the second bracket body 131. When the handheld gimbal 100 is in the folded state, the matching member 142 matches the handle 110. The extension direction of the second bracket body 142 is approximately parallel to the extension direction of the handle 110. In some embodiments, when the handheld gimbal 110 is in the folded state, the matching member 142 may partially or entirely abut against the handle 110. The matching member 142 and the handle 110 may also be arranged at an interval.

In some embodiments, to reduce the overall volume of the folded handheld gimbal 100, a size of the second bracket body 141 in the extension direction is less than a sum of the size of the handle 110 and the first motor 121 in the extension direction of the handle 110. In some embodiments, the length of the handle 110 is a, the size of the first motor 121 in the extension direction of the handle 110 is b, the size of the second bracket body 141 in the extension direction of the second bracket body 141 is d, then the sum of a and b is larger than d.

As shown in FIG. 1 to FIG. 11, a connection part of the first hinge member 161 and the first motor 121, the connection part of the second hinge member 162 and the first connection bracket 130, the connection part of the first connection bracket 130 and the third hinge member 171, the connection part of the fourth hinge member 172 and the second motor 122, the connection part of the fifth hinge member 181 and the second motor 122, the connection part of the sixth hinge member 182 and the second connection bracket 140, the connection part of the second connection bracket 140 and the third motor 123, and the connection part of the carrier structure 150 and the third motor 123 may be an integrated structure. As such, the number of parts can be reduced, thereby facilitating assembly and improving the production efficiency of the handheld gimbal 100.

In some embodiments, at least one of the connection part of the first hinge member 161 and the first motor 121, the connection part of the second hinge member 162 and the first connection bracket 130, the connection part of the first connection bracket 130 and the third hinge member 171, the connection part of the fourth hinge member 172 and the second motor 122, the connection part of the fifth hinge member 181 and the second motor 122, the connection part of the sixth hinge member 182 and the second connection bracket 140, the connection part of the second connection bracket 140 and the third motor 123, or the connection part of the carrier structure 150 and the third motor 123 may be molded separately.

In some embodiments, the first connection bracket 130 and the second connection bracket 140 may be in any suitable shape, such as L shape.

As shown in FIG. 8, the handheld gimbal 100 also includes a control assembly 190 arranged at the handle 110. The control assembly is configured to execute control functions to control the handheld gimbal 100 and/or the load 200. In some embodiments, the control assembly 190 includes an operation member 191 and a controller (not shown). The operation member 191 is arranged at the handle 110. The operation member 191 may be configured to receive input information. The controller may be arranged inside the handle 110. The controller may be configured to execute corresponding operations according to the input information.

Users may input information through the operation member 191. The controller controls the handheld gimbal 100 according to the input information, thereby changing the attitude of the load 200. For example, when using the handheld gimbal 100, the user may input information through the operation member 191 to determine a preset attitude of the load 200, so as to cause the load 200 to achieve the preset effect. The operation member 191 may also execute control functions to control the load 200, such as starting or stopping the photographing and recording, turning photo pages, playing videos or photos, etc., which is convenient for users to use, thereby improving user experience.

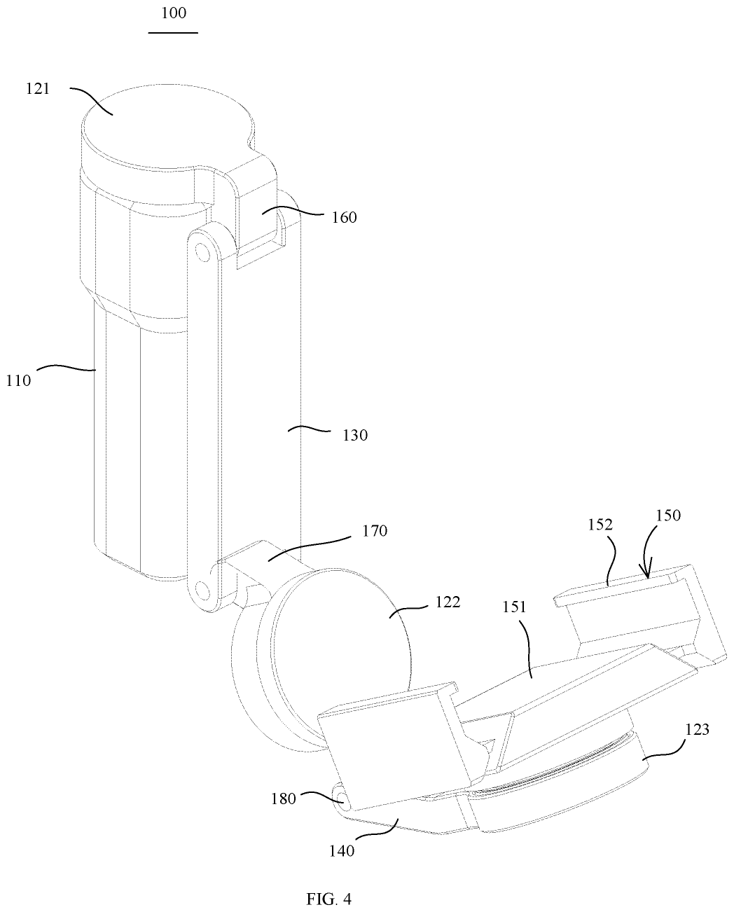

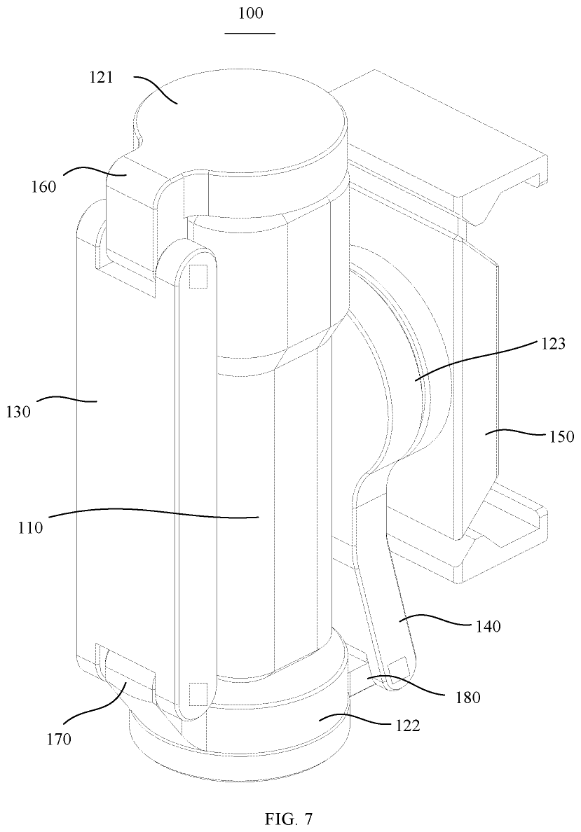

When the handheld gimbal in the unfolded state shown in FIG. 1 or FIG. 2 needs to be switched to the folded state shown in FIG. 6 or FIG. 7, an external force is applied to cause the first connection bracket 130 to rotate around the first shaft assembly 163 with the angle of 120°, so that the first connection bracket 130 may at least partially abut against the side wall 113 of the handle 110. At this time, the handle 110 and the second motor 122 are respectively arranged at two sides of the first connection bracket 130. The second motor 122, the second connection bracket 140, the third motor 123, and the carrier structure 150 are arranged at the same side of the first connection bracket 130. As shown in FIG. 4 and FIG. 5, the external force is further applied to cause the third motor 123 to rotate around the second shaft assembly 173 in the direction toward the handle 110 about 120° so that the second motor 122 at least partially abut against the bottom 112 of the handle 110. At this time, the first motor 121 and the second motor 122 are respectively arranged at the top 111 of the handle 110 and the bottom 112 of the handle 110. The axis of the first motor shaft Y is approximately parallel to the axis of the second motor shaft P. The external force is further applied to make the second connecting bracket 140 rotate around the third shaft assembly 183, so that the first motor shaft Y and the third motor shaft R are approximately perpendicular. As such, the handheld gimbal 100 is in the folded state and the state is locked, and the handheld gimbal 100 occupies a small space and has a compact structure.

In some embodiments, when the handheld gimbal 100 is in the folded state, the third motor 123 may partially or entirely abut against the side wall 113 of the handle 110. The first motor shaft Y and the second motor shaft P are coaxially arranged. In some embodiments, when the handheld gimbal 100 is in the folded state, the third motor shaft R is arranged on the side of the handle 110. The first connecting bracket 130 and the third motor 123 are oppositely arranged at two sides of the handle 110, and the third motor 123 and the second connection bracket 140 are arranged at the same side of the handle 110. In some embodiments, when the handheld gimbal 100 is in the folded state, the third motor 123 may be arranged between the handle 100 and the carrier structure 150.

The above-described handheld gimbal 100 may be switched between the folded state and the unfolded state. When the handheld gimbal 100 is in the folded state, the handheld gimbal 100 has a compact structure and occupies a small space, which is convenient for user to carry, thereby effectively improving the portability of the handheld gimbal 100.

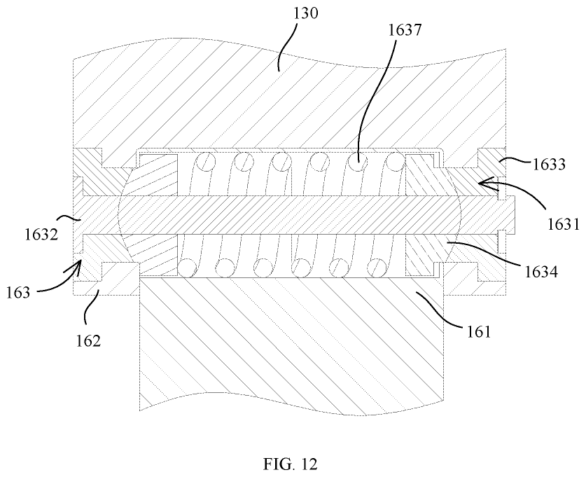

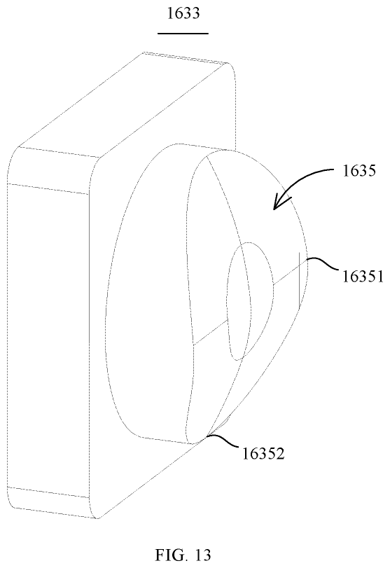

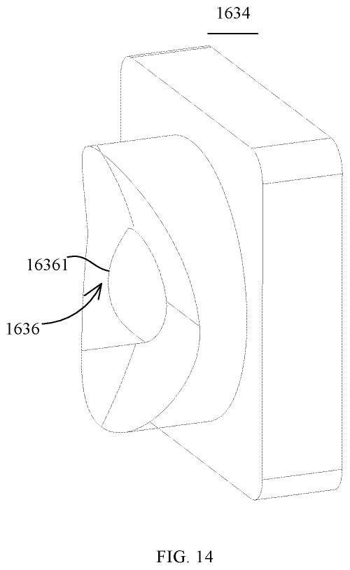

In some embodiments, as shown in FIG. 12 to FIG. 15, the first shaft assembly 163 includes a first lock mechanism 1631 and a first shaft 1632. The first lock mechanism 1631 is arranged between the first hinge member 161 and the second hinge member 162. The first lock mechanism 1631 is configured to lock the relative rotation between the first hinge member 161 and the second hinge member 162, so as to lock the first connection bracket 130 and the first motor 121 in the unfolded state or the folded state. The first shaft 1632 penetrates through the first lock mechanism 1631, and the first shaft 1632 penetrates through at least one of the first hinge member 161 or the second hinge member 162 to hinge the first motor 121 and the first connection bracket 130.

As shown in FIG. 12 to FIG. 15, the first connection bracket 130 is locked relative to the first motor 121 in any one of the folded state, the unfolded state, or other intermediate states. As such, the reliability of the handheld gimbal 100 may be improved. The first lock mechanism 1631 is also arranged between the first hinge member 161 and the second hinge member 162. The first lock mechanism 1631 can lock the relative position of the first hinge member 161 and the second hinge member 162, so that the above-described handheld gimbal 100 may be maintained in a stable state described above. When the first lock mechanism 1631 is locked, the first hinge member 161 and the second hinge member 162 cannot rotate relative to each other. When the first lock mechanism 1631 is unlocked, the first hinge member 161 and the second hinge member 162 can rotate relative to each other.

In some embodiments, the first lock mechanism 1631 may be any suitable lock structure, as long as the first lock mechanism can lock the relative rotation between the first connection bracket 130 and the first motor 121. For example, the first lock mechanism 1631 may include at least one of an inclined plane lock structure, an eccentric lock structure, a four-bar lock structure, or a buckle lock structure.

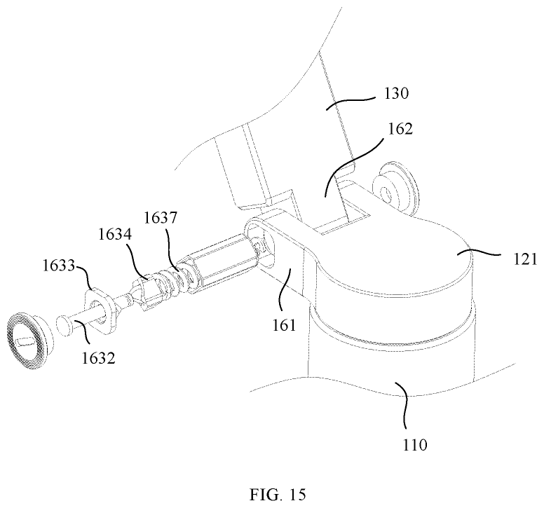

As shown in FIG. 12 and FIG. 15, the first lock mechanism 1631 includes a first lock member 1633 and a second lock member 1634. The first lock member 1633 is arranged at the first hinge member 161. The second lock member 1634 is arranged at the second hinge member 162. The second lock member 1634 can cooperate with the first lock member 1633 to switch the first connection bracket 130 between the unfolded state and the folded state with respect to the first motor 121.

As shown in FIG. 12 to FIG. 15, at least one of the first lock member 1633 or the second lock member 1634 includes a convex structure 1635. When the first lock member 1633 and the second lock member 1634 rotate relative to each other, a distance between the first lock member 1633 and the second lock member 1634 is increased through the convex structure 1635. A contact point between the first lock member 1633 and the second lock member 1634 rotates along the convex structure 1635. When the contact point between the first lock member 1633 and the second lock member 1634 reaches the highest point of the convex structure 1635, the first connection bracket 130 is at a corresponding working state. When the contact point between the first lock member 1633 and the second lock member 1634 reaches the lowest point of the convex structure 1635, the first connection bracket 130 is at another working state. In some embodiments, the two working states of the first connection bracket 130 may be the folded state and the unfolded state, respectively.

As shown in FIG. 12 to FIG. 15, in some embodiments, the convex structure 1635 is arranged at the first lock member 1633. A concave structure 1636 matching the convex structure 1635 is arranged at the second lock member 1634. In some embodiments, a concave structure 1636 may be arranged at first lock member 1633. The convex structure 1635 matching the concave structure 1636 are arranged the second lock member 1634. The concave structure 1636 and the convex structure 1635 cooperate with each other to realize the cooperation of the first lock member 1633 and the second lock member 1634. When the first connection bracket 130 rotates relative to the first motor 121 through the first hinge structure 160, the second lock member 1634 may rotate around the first shaft 1632.

As shown in FIG. 12 and FIG. 15, the first lock mechanism 1631 may further include a first elastic member 1637. The first elastic member 1637 is arranged at the second lock member 1634. The first elastic member 1637 is configured to provide elastic force for the first lock member 1633 and the second lock member 1634. When the first connection bracket 130 is in the unfolded or folded state, an elastic moment of the first elastic member 1637 is not equal to zero, which can stabilize the first connection bracket 130 at the unfolded or the folded state, thereby avoiding the shaking of the first connection bracket of 130 and improving the connection reliability and stability of the first connection bracket 130, and ensuring the reliable operation of the handheld gimbal 100 within the folding range.

As shown in FIG. 12, in some embodiments, the number of the first lock member 1633 and the number of the second lock member 1634 are both two. The two second lock members 1634 abut against two ends of the first elastic member 1637, respectively. As such, the first connection bracket 130 may be further stabilized at the unfolded state or the folded state, thereby further improving the reliability and stability of the first connection bracket 130. In some embodiments, the number of the first lock member 1633 and the second lock member 1634 may be any suitable number. For example, the number of the first lock member 1633 and the second lock member 1634 may both be one. One end of a first elastic member 1637 abuts against the second lock member 1634, and the other end abuts against the second hinge member 162.

As shown in FIG. 12 to FIG. 14, in some embodiments, the convex structure 1635 includes two convex highest points 16351, and two convex lowest points 16352. The concave structure 1636 includes two concave lowest points 16361. The two convex highest points 16351 and the two concave lowest points 16361 form two dead point positions for the rotation of the first shaft 1632. In the above-described two positions, the concave structure 1636 and the convex structure 1635 can closely match each other to form the folded state or the unfolded state of the first connection bracket 130. In some embodiments, the line connecting the two convex highest points 16351 is approximately perpendicular to the line connecting the two concave lowest points 16352.

As shown in FIG. 15, the first lock mechanism 1631 may include a sleeve (not labeled) sleeved on the outside of the first elastic member 1637 and the first shaft 1632, and a clamping member (not labeled) for clamping and fixing the first rotating shaft 1632 on the first hinge member 161 or the second hinge member 162.

For the above-described handheld gimbal 100, the first connection bracket 130 may rotate relative to the first motor 121 between the unfolded position and the folded position. For the first connection bracket 130, during the switching process from the unfolded state or the folded state to the other, the first lock member 1633 and the second lock member 1634 rotate relative to each other. During the movement, the second lock member 1634 moves along the axial direction of the first shaft 1632, compresses the first elastic member 1637, causes the first elastic member 1637 to be elastically deformed, and generates elastic force. When the first lock member 1633 and the second lock member 1634 rotate for a certain angle and reach a matching angle, under the elastic force of the first elastic member 1637, the first lock member 1633 and the second lock member 1634 may tightly match each other. Then, the elastic force of the first elastic member 1637 keeps the first connection bracket 130 in the unfolded or the folded state. Therefore, the above-described handheld gimbal 100 does not need to be locked manually, and the first connection bracket 130 can be fixed by only rotating the first connection bracket 130 in the unfolded state and the folded state,

In some embodiments, the convex structure 1635 may include a plurality of protrusions (not shown), and the concave structure 1636 may include a plurality of grooves (not shown) that cooperate with the protrusions. A bottom wall of a groove is an arc-shaped inclined surface, and a protrusion includes a matching surface (not shown) that matches the arc-shaped inclined surface. The contact point of the first lock member 1633 and the second lock member 1634 rotates around the arc-shaped inclined surface or the matching surface. When the contact point of the first lock member 1633 and the second lock member 1634 is arranged at the highest point of the matching surface, the first connection bracket 130 is at a certain working state. When the contact point of the first lock member 1633 and the second lock member 1634 is arranged at the lowest point of the matching surface, the first connection bracket 130 is at another working state.

In some embodiments, the plurality of protrusions may be arranged at intervals along the circumferential direction of the first shaft 1632. In some embodiments, the plurality of protrusions is arranged at equal intervals along the circumferential direction of the first shaft 1632. The number of protrusions may be two, three, four, or more.

The above-described handheld gimbal 100 may be switched between the folded state and the unfolded state. When the handheld gimbal 100 is in the folded state, the handheld gimbal 100 has a compact structure and occupies a small space, which is convenient for user to carry, thereby effectively improving the portability of the handheld gimbal 100. In addition, the first lock mechanism 1631 of the first shaft assembly 163, the lock mechanism of the second shaft assembly 173, and the lock mechanism of the third shaft assembly 183 may lock the handheld gimbal at the folded or unfolded state, thereby improving the reliability of the handheld gimbal 100.

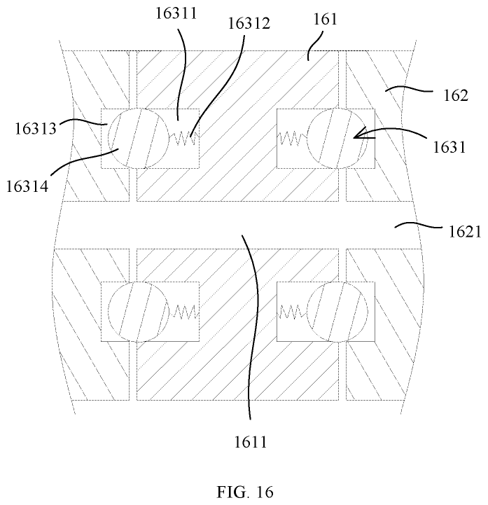

Another example of the handheld gimbal 100 is described below in connection with FIG. 1 to FIG. 11, and FIG. 16, the structure of which is approximately the same as that of the above-described example handheld gimbal 100, except that the structure of the first lock mechanism 1631 is different, as shown in FIG. 16.

As shown in FIG. 16, the first lock mechanism 1631 includes a first limit hole 16311, a second elastic member 16312, a second limit hole 16313, and a positioning member 16314.

In some embodiments, the first limit hole 16311 is arranged at the first hinge member 161. The number of the first limit holes 16311 is two, and the two first limit holes 16311 are symmetrically arranged on the first hinge member 161 along the radial direction of the first shaft 1632. To facilitate manufacturing and improve the operability of the handheld gimbal 100, the size and structure of the two first limit holes 16311 are approximately the same.

One end of the second elastic member 16312 abuts against the bottom wall of the first limit hole 16311, and the other end of the second elastic member 16312 abuts against the positioning member 16314. The second limit hole 16313 is arranged at the second hinge member 162 corresponding to the first limit hole 16311. The positioning member 16314 may be partially stored in the second limit hole 16313 under the action of the second elastic member 16312, thereby locking the relative rotation of a connection bracket 130 and the first motor 121. When the first connection bracket 130 rotates relative to the first motor 121 under the action of an external force, the positioning member 16314 may compress the second elastic member 16312, so that the positioning member 16314 may be separated from the second limit hole 16313, as such, the first connection bracket 130 and the first motor 121 may rotate relative to each other.

In some embodiments, the shape of the second limit hole 16313 and that of the positioning member 16314 may be any suitable shape, as long as they can cooperate to facilitate the positioning member 16314 to enter or leave the second limit hole 16313. For example, the shape of the positioning member 16314 may be spherical, and the second limit hole 16313 is a circular hole that matches the positioning member 16314. The number of the first lock mechanism 1631 may also be any suitable number, for example, one, two, or more. When the number of the first lock mechanism 1631 is more than one, the plurality of first lock mechanisms 1631 are arranged at intervals along the circumferential direction of the first shaft 1632 to further improve the reliability of the handheld gimbal 100.

The above-described handheld gimbal 100 may be switched between the folded state and the unfolded state. When the handheld gimbal 100 is in the folded state, the handheld gimbal 100 has a compact structure and occupies a small space, which is convenient for users to carry, thereby effectively improving the portability of the handheld gimbal 100. In addition, the first lock mechanism 1631 of the first shaft assembly 163 and the lock mechanism of the second shaft assembly 173 may lock the handheld gimbal 100 in the folded or the unfolded state, thereby improving the reliability of the handheld gimbal 100.

In the description of the present disclosure, unless otherwise specified and defined, the terms “mount,” “connect,” or “connection” should be understood in a broad sense. For example, the connection may be a fixed connection, a detachable connection, or in one piece. The connection may further be a mechanical connection or an electrical connection. The connection may be a direct connection or an indirect connection through an intermediate medium. The connection may also be an internal communication between two components or an interaction relationship between two components. For those of ordinary skill in the art, the specific meanings of the above terms in the present disclosure may be understood according to specific circumstances.

In embodiments of the present disclosure, unless otherwise specified and defined, a first feature being “above” or “below” a second feature may include the direct contact of the first and second features or may include indirect contact of the first and second features through another feature therebetween. Moreover, a first feature being “above,” “on,” or “over” a second feature includes that the first feature is directly above or obliquely above the second feature, or simply means that the first feature is higher in level than the second feature. The first feature being “below,” “under,” or “beneath” a second feature includes that the first feature is directly under or obliquely under the second feature, or simply means that the first feature is lower in height than the second feature.

The present disclosure provides many various implementations or examples to implement different structures of embodiments of the present disclosure. To simplify embodiments of the present disclosure, components and settings of specific examples are described above. The description is merely exemplary and does not intend to limit embodiments of the present disclosure. Reference numerals and/or letters are repeated in different examples in embodiments of the present disclosure for simplicity and clarity, and do not indicate relationship among various implementations and/or settings. Embodiments of the present disclosure provide examples of various specific processes and materials, but those of ordinary skill in the art may be aware of application of other processes and/or use of other materials.

In this specification, description with the terms “one embodiment,” “certain embodiments,” “examples,” “specific examples,” or “some embodiments,” etc., means that specific features, structures, materials, or characteristics described in connection with embodiments or examples are included in at least one embodiment or example of the present disclosure. In the present disclosure, the schematic description of the above terms does not necessarily refer to a same embodiment or example. Moreover, the described specific features, structures, materials, or characteristics may be combined in any suitable manner in any one or more embodiments or examples.

Although implementation manners of the present disclosure are shown and described above. Those of ordinary skill in the art may understand that changes, modifications, replacements, and transformations can be made on above-described embodiments without departing from the principle and purpose of the present disclosure. The scope of the invention is defined by the claims and their equivalents.

What is claimed is:

1. A foldable handheld gimbal comprising:
a handle having a top, a bottom, and a side wall arranged between the top and the bottom;
a first motor arranged at the top of the handle and configured to drive a load to rotate around a first motor shaft;
a first connection bracket with one end of the first connection bracket connected to the first motor;
a second motor connected to another end of the first connection bracket and configured to drive the load to rotate around a second motor shaft;
a second connection bracket with one end of the second connection bracket connected to the second motor;
a third motor connected to another end of the second connection bracket and configured to drive the load to rotate around a third motor shaft;
a carrier structure fixedly connected to a rotor of the third motor and configured to carry the load;
a first hinge structure hinged to the first motor and the first connection bracket; and
a second hinge structure hinged to the first connection bracket and the second motor;
wherein the first connection bracket and the second motor are configured to rotate around the first hinge structure and the second hinge structure, respectively, to switch the handheld gimbal among a plurality of states including a folded state, in which the first motor and the second motor are arranged at the top and the bottom of the handle, respectively.

2. The foldable handheld gimbal according to claim 1, wherein when the handheld gimbal is in the folded state:
an axis of the first motor shaft is approximately parallel to an axis of the second motor shaft; or
the first motor shaft and the second motor shaft are coaxially arranged.

3. The foldable handheld gimbal according to claim 1, wherein when the handheld gimbal is in the folded state:
the first motor shaft is approximately perpendicular to the third motor shaft.

4. The foldable handheld gimbal according to claim 1, wherein when the handheld gimbal is in the folded state:
the third motor shaft is located at a side of the handle; and
the first connection bracket and the third motor are located at two opposite sides of the handle.

5. The foldable handheld gimbal according to claim 4, wherein a length of the first connection bracket is less than or equal to a length of the handle.

6. The foldable handheld gimbal according to claim 4, wherein when the handheld gimbal is in the folded state:
the third motor and the second connection bracket are located at a same side of the handle; and
the third motor is located between the handle and the carrier structure.

7. The foldable handheld gimbal according to claim 1, wherein the first hinge structure includes:
a first hinge member extending outward from an outer periphery of the first motor;
a second hinge member extending from an end of the first connection bracket that is away from the second motor; and
a shaft assembly connected to the first hinge member and the second hinge member and configured to hinge connect the first motor and the first connection bracket.

8. The foldable handheld gimbal according to claim 7, wherein:
the first hinge member extends outward from a side periphery of the first motor;
the first hinge member is arranged at an end of the shaft assembly and the second hinge member is arranged at a middle of the shaft assembly;
the first hinge member is arranged at the middle of the shaft assembly and the second hinge member is arranged at the end of the shaft assembly; or
the first hinge member is arranged at one end of the shaft assembly and the second hinge member is arranged at another end of the shaft assembly.

9. The foldable handheld gimbal according to claim 7, wherein the shaft assembly includes:
a lock mechanism arranged between the first hinge member and the second hinge member and configured to lock a relative rotation between the first hinge member and the second hinge member, to lock the first connection bracket in an unfolded state or the folded state; and
a shaft penetrating at least one of the first hinge member or the second hinge member to hinge connect the first motor and the first connection bracket.

10. The foldable handheld gimbal according to claim 9, wherein the lock mechanism includes:
a first lock member arranged at the first hinge member;
a second lock member arranged at the second hinge member and configured to cooperate with the first lock member to enable the first connection bracket to switch with respect to the first motor among the plurality of states; and
an elastic member arranged at the first lock member and configured to provide an elastic force to the first lock member and the second lock member.

11. The foldable handheld gimbal according to claim 9, wherein:
the elastic member is a first elastic member; and
the lock mechanism further includes:
two first limit holes symmetrically arranged at the first hinge member or the second hinge member along a radial direction of the shaft;
a second elastic member, one end of the second elastic member abutting against at least one of the first limit holes;
a second limit hole arranged at the second hinge member or the first hinge member; and
a positioning member abutting against another end of the second elastic member and partially received in the second limit hole, the positioning member being configured to compress the second elastic member to escape from the second limit hole when the first connection bracket rotates relative to the first motor.

12. The foldable handheld gimbal according to claim 7, wherein:
the shaft assembly is a first shaft assembly; and
the second hinge structure includes:
a third hinge member extending from one end of the first connection bracket that is away from the first motor;
a fourth hinge member extending outwards from an outer periphery of the second motor; and
a second shaft assembly connected to the third hinge member and the fourth hinge member, to hinge connect the first connection bracket and the second motor.

13. The foldable handheld gimbal according to claim 12, wherein:
the fourth hinge member extends outwards from a side periphery of the second motor;
the third hinge member is arranged at an end of the second shaft assembly, and the fourth hinge member is arranged at a middle of the second shaft assembly;
the third hinge member is arranged at the middle of the second shaft assembly, and the fourth hinge member is arranged at the end of the second shaft assembly; or
the third hinge member is arranged at one end of the second shaft assembly, and the fourth hinge member is arranged at another end of the second shaft assembly.

14. The foldable handheld gimbal according to claim 12, further comprising:
a third hinge structure hinged to the second motor and the second connection bracket, and including:
a fifth hinge member extending outwards from a outer periphery of the second motor;
a sixth hinge member extending from one end of the second connection bracket that faces the second motor; and
a third shaft assembly connected to the fifth hinge member and the sixth hinge member, to hinge connect the second motor and the second connection bracket.

15. The foldable handheld gimbal according to claim 14, wherein:
the fourth hinge member and the fifth hinge member are arranged at two sides of the second motor, respectively;
when the handheld gimbal is in an unfolded state, an angle between an extension direction of the fourth hinge member and an extension direction of the fifth hinge member is in a range of 75°˜105°;
when the handheld gimbal is in the folded state, the angle between the extension direction of the fourth hinge member and the extension direction of the fifth hinge member is in a range of 165°˜180°;
the fifth hinge member is arranged at an end of the third shaft assembly, and the sixth hinge member is arranged at a middle of the third shaft assembly;
the fifth hinge member is arranged at the middle of the third shaft assembly, and the sixth hinge member is arranged at the end of the third shaft assembly; or
the fifth hinge member is arranged at one end of the third shaft assembly, and the sixth hinge member is arranged at another end of the third shaft assembly.

16. The foldable handheld gimbal according to claim 1, wherein the first connection bracket includes:
a bracket body with two ends of the bracket body being connected to the first motor and the second motor, respectively; and
a plane member arranged at a side of the bracket body and configured to partially abut against the handle when the handheld gimbal is in the folded state.

17. The foldable handheld gimbal according to claim 16, wherein:
the plane member is a first plane member;
when the handheld gimbal is in the folded state, an extension direction of the bracket body is approximately parallel to an extension direction of the handle;
the first connection bracket further includes a second plane member; and
the first plane member and the second plane member are arranged oppositely at two sides of the bracket body, respectively.

18. The foldable handheld gimbal according to claim 1, wherein
the bracket body is a first bracket body;
wherein the second connection bracket includes:
a second bracket body with one end connected to the second motor and another end connected to the third motor; and
a matching member arranged at a side of the second bracket body and configured to match the handle when the handheld gimbal is in the folded state.

19. The foldable handheld gimbal according to claim 18, wherein:
an extension direction of the second bracket body is approximately parallel to an extension direction of the handle when the handheld gimbal is in the folded state; and
a size of the second bracket body in the extension direction of the second bracket body is smaller than a sum of a size of the handle and a size of the first motor in the extension direction of the handle.

20. The foldable handheld gimbal according to claim 1, wherein:
a rotation angle of the first connection bracket about a first hinge joint of the first hinge structure is in a range of 100°˜150°;
a rotation angle of the second motor about a second hinge joint of the second hinge structure is in a range of 100°˜150°; or a rotation angle of the second connection bracket about a third hinge joint is in a range of 135°˜215°.
